(19) United States
(12) Patent Application Publication
(10) Pub. No.: US 2007/0024420 A1
(43) Pub. Date: Feb. 1, 2007

(54) Handle device in vehicle

(75) Inventors: Shinya Watanabe, Seto-shi (JP); Hiroki Tsuge, Aichi-ken (JP); Tatsuya Oba, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/495,899

(22) Filed: Jul. 31, 2006

(30) Foreign Application Priority Data
Aug. 1, 2005 (JP) 2005-223166

(51) Int. Cl. G05B 19/00

(52) U.S. Cl. 340/5.72; 340/5.62; 340/426.28

(57) ABSTRACT

A handle device adapted in a vehicle includes a touch-type switch provided on an operation handle for opening and closing an vehicle door so as to extend in a longitudinal direction of the operation door, so as to open and close the vehicle door, and an illuminating portion provided so as to extend along the touch-type switch in parallel thereto. The touch-type switch is provided to be offset relative to an illuminating direction of the illuminating portion. The illuminating portion preferably has a plurality of LED lamps. Furthermore, the touch-type switch is preferably an electrostatic capacity type switch.

### FIELD OF THE INVENTION

The present invention relates to a handle device adapted in a vehicle having a switch for locking and unlocking an vehicle door.

### RELATED ART

Conventionally, there is known an illuminating system including a light source and a light guiding plate that is disposed on a front side of a license plate (for example, refer to JP-A-2003-237463).

In addition, there is also known a waterproof door opening and closing control switch which includes a base mounted on a panel which makes up a covering and uncovering part of a vehicle body and a push rod which is supported on the base so as to be moved against a biasing force by being pushed on a head portion which is exposed from a hole in the panel to open or close a contact (for example, refer to P JP-A-2002-175736).

Furthermore, there is known a door lock control system in which an answer-back indicator lamp configured integrally with a request switch is provided in a central portion of the request switch (for example, refer to JP-A-2004-251003).

In the conventional techniques shown in JP-A-2003-237463 and JP-A-2002-175736, however, an illuminating apparatus for illuminating a license plate is not disposed in consideration of the position of an operation switch for opening and closing an vehicle door. Consequently, in a case where the visibility is low as at night, in the event that the user is not familiar with the operation of the vehicle, there may be caused a risk that the user have difficulty in locating the position of the operation switch. In addition, the conventional technique shown in JP-A-2004-251003 only has an indicator function to indicate the position of a switch and does not have a function to illuminate an automotive member such as the license plate.

### SUMMARY OF THE INVENTION

The invention was made to solve the problems inherent in the conventional techniques and a main object thereof is to increase the operability of the vehicle.

With a view to attaining the object, according to a first aspect of the invention, there is provided a handle device adapted in a vehicle including a touch-type switch provided on an operation handle for opening and closing an vehicle door so as to extend in a longitudinal direction of the operation door, so as to open and close the vehicle door, and an illuminating portion provided so as to extend along the touch-type switch in parallel thereto, wherein the touch-type switch is provided to be offset relative to an illuminating direction of the illuminating portion.

In the first aspect of the invention, the touch-type switch is provided to be offset relative to the illuminating direction of the illuminating portion, whereby the position of the touch-type switch can be recognized easily visually by the user while illuminating the automotive member such as the license plate. Consequently, the user can easily recognize the position of the touch-type switch to operate it an ensured fashion. Furthermore, since the touch-type switch is provided to extend along the longitudinal direction of the operation handle, a sensitive portion of the touch-type switch can be secured over a wider range, whereby the user can operate the touch-type switch as long as he or she can generally recognize the position thereof, the operability being thereby increased.

Note that the touch-type switch means, for example, a switch which can be operated to be switched on and off without requiring much operation force only by being lightly touched by the user. In addition, the operation handle means, for example, an automotive member to which the user applies an operation force when opening or closing the vehicle door.

In this case, according to a second aspect of the invention, there is provided a handle device adapted in a vehicle according to the first aspect of the invention, wherein the illuminating portion may have a plurality of LED lamps. Thus, by illuminating using the LED lamps, power consumption can be reduced. In addition, since the LED lamps have superior weatherability and shock impact resistance, the application of the LED lamps in that way contributes to cost reduction.

In addition, according to a third aspect of the invention, there is provided a handle device adapted in a vehicle according to the first or second aspect of the invention, wherein the touch-type switch may be an electrostatic capacity type switch. Thus, a wide switch sensitive area can be secured by the arrangement of electrodes, and therefore, the application of the LED lamps in that way contributes to increase in operability.

Furthermore, according to a fourth aspect of the invention, there is provided a handle device adapted in a vehicle according to the third aspect of the invention, wherein the electrostatic capacity type switch may have a pair of electrodes and a detection circuit for detecting a change in electrostatic capacity between the electrodes.

According to a fifth aspect of the invention, there is provided a handle device adapted in a vehicle according to any of the first to fourth aspects of the invention, wherein the vehicle door is, for example, a side door, a tailgate, a rear door or a trunk lid.

According to the invention, the operability of the vehicle can be increased.

### BRIEF DESCRIPTION OF THE DRAWINGS

FIG. 1 is a sectional view showing a state in which a handle device adapted in a vehicle according to an embodiment of the invention is mounted on a tailgate of a vehicle.

FIG. 2 is a sectional view of the handle device adapted in a vehicle according to the embodiment of the invention, which is a partially enlarged view showing a portion A in FIG. 1 in an enlarged fashion.

FIG. 3 is a view resulting when the handle device adapted in a vehicle shown in FIG. 2 is viewed from a direction B.

FIG. 4 is a diagram showing an example of a detection circuit of an electrostatic capacity type switch.

### DETAILED DESCRIPTION OF THE PREFERRED EMBODIMENTS

Hereinafter, referring to the accompanying drawings, embodiments of the invention will be described by raising an embodiment of the invention. Note that since the basic concept, main hardware configuration, operating principle and basic control method of the handle device adapted in a vehicle are known to those skilled in the art to which the subject invention pertains, the detailed description thereof will be omitted herein.

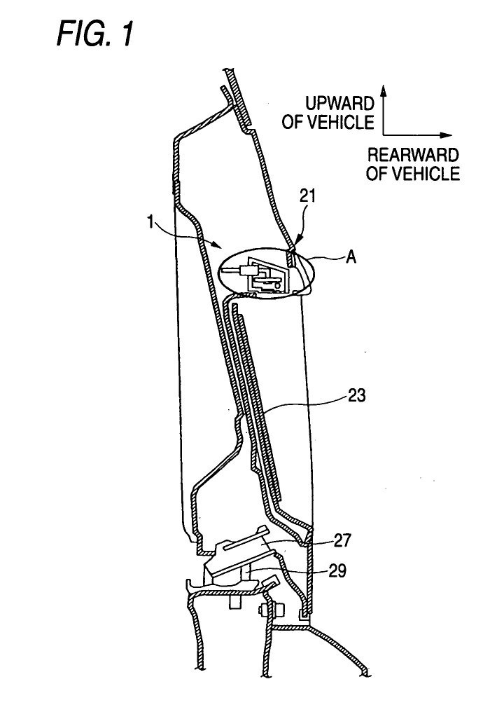

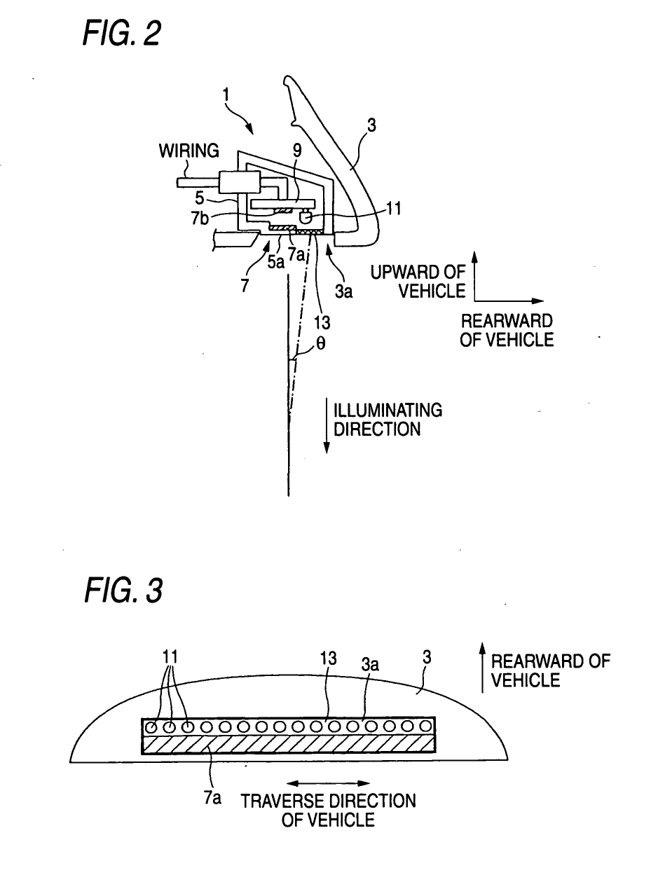

FIG. 1 is a sectional view showing a state in which a handle device adapted in a vehicle according to an embodiment of the invention is mounted on a tailgate of a vehicle. FIG. 2 is a sectional view of the handle device adapted in a vehicle according to the embodiment of the invention, which is a partially enlarged view showing a portion A in FIG. 1 in an enlarged fashion. FIG. 3 is a view resulting when the handle device adapted in a vehicle shown in FIG. 2 is viewed from a direction B.

A handle device adapted in a vehicle 1 according to this embodiment is, as shown in FIG. 1, mounted on a tailgate 21 which is adapted to cover and uncover an opening at a rear portion of a vehicle and is disposed above a rectangular license plate 23. Note that the handle device adapted in a vehicle 1 may be mounted on an arbitrary door of the vehicle such as a rear door, a trunk lid and a side door.

The handle device adapted in a vehicle 1 extends in a transverse direction of the vehicle and is accommodated in an interior of a license plate garnish 3 which is formed of a synthetic resin. The license plate garnish 23 is formed into something like a turned-over L shape in cross section and is connected to the tailgate 21 at both end portions thereof. In addition, the shape of the license plate garnish 23 is formed to produce a shape which reduces the Cd value of the vehicle and increases the aerodynamic properties of a vehicle body in such a state that the license plate garnish 3 is mounted on the tailgate 21. An opening 3a is formed in the license plate garnish 3 so as to open downwards of the vehicle in a rectangular shape. In addition, a coating such as plating is applied to an external surface of the license plate garnish 3, so as to improve aesthetically its external appearance in terms of design.

A license plate lamp cover (an operation handle) 5 which extends in the transverse direction of the vehicle is accommodated within the license plate garnish 3. Note that a lower surface portion 5a of the license plate lamp cover 5 is fitted in the opening 3a formed in the license plate garnish 3. In such a fitted state, the lower surface portion 5a of the license plate lamp cover 5 and a lower surface portion of the license plate garnish 3 are made to lie substantially on the same plate. Consequently, the aforesaid aerodynamic properties of the vehicle body and aesthetic appearance in terms of design are maintained at a high level.

A touch-type switch 7 such as an electrostatic capacity type switch for unlocking the locked tail gate 21 is provided in the lower surface portion 5a in the interior of the license plate lamp cover 5.

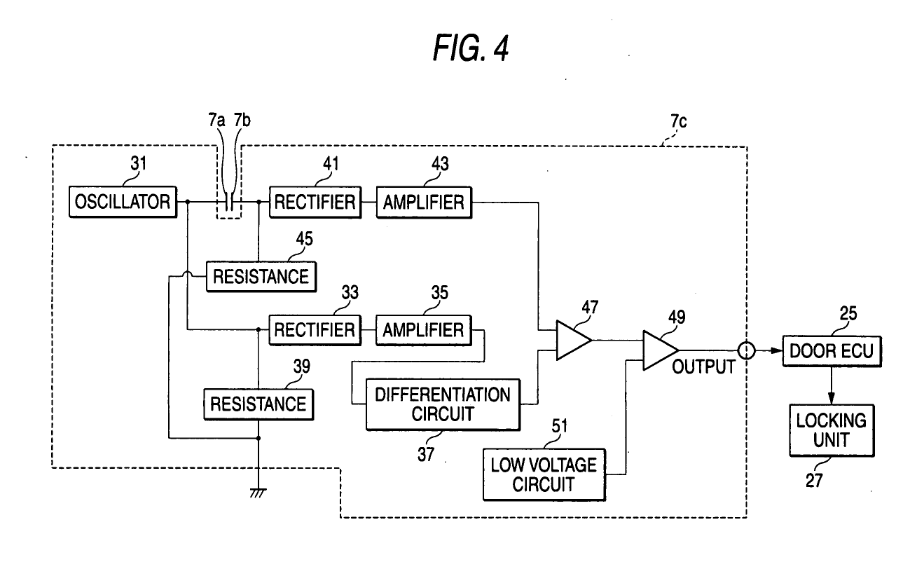

The electrostatic capacity type switch 7 is connected to a door ECU (Electronic Control Unit) 25 for controlling the locking/unlocking of the vehicle door via wiring (FIG. 4). The electrostatic capacity type switch 7 is switched between an ON state and an OFF state by being touched to be operated by the user. When the electrostatic capacity type switch 7 is switched to the ON state, an ON signal is sent to the door ECU 25, whereas when the electrostatic capacity type switch 7 is switched to the OFF state, an OFF signal is sent to the door ECU 25. When receiving the ON signal from the electrostatic capacity type switch 7, the door ECU 25 sends an unlocking signal to a locking unit 27. When receiving the unlocking signal, the locking unit 27 drives a driving unit such as a solenoid and a motor, whereby a latch is moved so as to release an engagement with a striker 29 in an opening in the vehicle, and thus, the tailgate 21 is unlocked (FIG. 1).

The electrostatic capacity type switch 7 has a pair of electrodes 7a, 7b and a detection circuit 7c for detecting a change in electrostatic capacity between the pair of electrodes 7a, 7b (FIG. 4). The electrode 7a, which is one of the pair of electrodes 7a, 7b, is provided in a substantially rectangular shape in the lower surface portion 5a of the license plate lamp cover 5 so as to extend in the transverse direction of the vehicle. The other electrode 7b is provided a predetermined minute distance apart from the electrode 7a. In addition, the pair of electrodes 7a, 7b is provided in such a state that the electrodes face each other and are insulated electrically from each other. The detection circuit 7c is provided on a substrate 9 accommodated within the license plate lamp cover 5. The other electrode 7b and the door ECU 25 are connected to the detection circuit 7c via wiring.

As shown in FIG. 4, the detection circuit 7c has an oscillator 31 which is connected to the electrode 7a and a rectifier 33 which is connected between the electrode 7a and the oscillator 31. An amplifier 35 is connected in series to the rectifier 33, and a differentiation circuit 37 is connected in series to the amplifier 35. A resistance 39 is provided between the electrode 7a and the ground, a rectifier 41 is connected to the electrode 7b, and an amplifier 43 is connected in series to the rectifier 41. A resistance 45 is provided between the electrode 7b and the ground, and a differential amplifier 47 is connected to the differentiation circuit 37 and the amplifier 43, so that outputs from the differentiation circuit 37 and the amplifier 43 are inputted to the differential amplifier 47 in parallel. One of input ends of a comparator 49 is connected to an output of the differential amplifier 47, and a low voltage circuit 51 is connected to the other input of the comparator 49. The comparator 49 outputs an ON signal to the door ECU 25 when electrostatic capacity between the pair of electrodes 7a, 7b exceeds a predetermined value.

When the user of the vehicle touches the electrode 7a in the lower surface portion 5a of the license plate lamp cover 5 in an attempt to unlock the tailgate 21, the electrostatic capacity between the pair of electrodes 7a, 7b changes. When the change in electrostatic capacity exceeds the predetermined value, the detection circuit 7c outputs an ON signal to the door ECU 25, whereby the intention of the user to unlock the tailgate can be confirmed accurately.

A plurality of bullet-shaped LED (Light Emitting Diode) lamps 11 for illuminating the license plate 23 are arranged in the transverse direction of the vehicle. Since the LED lamps 11 are arranged in the transverse direction of the vehicle in this way, light from the LED lamps 11 is emitted to the license plate 23 uniformly in the transverse direction of the vehicle, to thereby increase the visibility of the license plate 23.

Note that the LED lamp 11 is characterized in that it emits light when current flows in a forward direction therethrough. In addition, each LED lamp 11 may be made up of a single LED or be made up of a unit in which a plurality of LED's are combined together. Furthermore, each LED lamp 11 may be defined by partition plates (not shown). For example, when a unit made up of a combination of a red LED, a green LED and a blue LED is illuminated, the LED lamp 11 is allowed to emit white light.

A terminal of each LED lamp is connected to a wiring pattern (not shown) formed on the substrate 9, and the wiring pattern is connected to a light ECU (not shown). The plurality of LED lamps 11 are made to emit light based on light emitting signals sent from the light ECU.

Note that while the bullet-shaped LED lamps are used as the LED lamps 11, the invention is not limited thereto, and hence, various shapes including a chip shape can be used. In addition, while the LED lamps 11 are made to emit while light, the invention is not limited thereto, and hence, the LED lamps 11 may be made to emit light within the visible range such as red, yellow, blue and green. In the event that the LED lamps 11 are made to emit white light, it is possible to configure such that numbers indicated on the license plate 23 and the background thereof are visualized in their original colors.

As an advantage of utilization of the LED lamp 11, there are raised small power consumption and heat value and long life, and therefore, the LED lamp 11 is preferable for long and continuous illumination. In addition, since the LED lamp 11 is small in size, a space therefor can easily be secured in the event that the LED lamp is attempted to be accommodated within the license plate lamp cover 5. Consequently, the handle device adapted in a vehicle 1 can be made small in size and thinned in thickness. Additionally, since the LED lamp 11 has superior durability, the LED lamp 11 is advantageous in service and maintenance. Furthermore, since the LED lamp 11 has superior weatherability and shock impact resistance, the LED lamp 11 is durable for long use outside a passenger compartment. Since the LED lamp 11 exhibits a highly bright and clear color, an effective illumination becomes possible even under an environment where illumination of intensity is high as under daylight. Furthermore, the LED lamp 11 has a wide visual field angle, the LED lamp 11 can be visualized from a wide range. In view of these advantages, the LED lamp 11 is preferable as a lamp disposed outside the passenger compartment. Note that while the plurality of LED lamps 11 are arranged on the substrate 9 within the license plate lamp cover 5, the invention is not limited thereto, and hence, an electric lamp (bulb), a fluorescent lamp, a cold-cathode tube or the like may be arranged thereon.

Lenses 13 are provided in parallel to the electrode 7a, one of the plurality of electrodes 7a, 7b, which is provided in the transverse direction of the vehicle in the lower surface portion 5a of the license plate lamp cover 5. In addition, the pair of electrodes 7a, 7b and the plurality of LED lamps 11 are provided to be offset relative to the illuminating direction of the LED lamps 11, and the lens 13 is provided in the illuminating direction of each of the LED lamps 11. Consequently, illumination light from the LED lamps 11 is firstly incident on the lenses 13. Light that has entered the lenses 13 is gathered by the lenses 13 and is then emitted from the lenses 13 on to the license plate 23 at a predetermined light distribution angle θ. Note that the light distribution angle θ is an angle made by a ray of light of the LED lamp relative to a vertical direction of the vehicle. In addition, while the plurality of lenses 13 are provided in the transverse direction of the vehicle in the lower surface portion 5a of the license plate lamp cover 5, a member made of polycarbonate resin, acrylic resin, epoxy resin or the like and hence having light transmission properties may be provided instead. Furthermore, while the pair of electrodes 7a, 7b is disposed longitudinally further inwards of the vehicle than the plurality of LED lamps 11 with a view to securing the predetermined light distribution angle θ, the pair of electrodes 7a, 7b is disposed longitudinally further outwards of the vehicle than the plurality of LED lamps 11. As this occurs, the user can operate the electrostatic capacity type switch 7 more easily.

In addition, the door ECU 25, the light ECU and a smart ECU, which will be described later on, are made up of a micro computer to execute various processings according to control and operation programs and have a CPU (Central Processing Unit) for controlling various units of the system, a ROM (Read Only Memory) for storing execution programs for the CPU, a readable and writable RAM (Random Access Memory) for storing operation results and the like, a timer, a counter, an input interface, an output interface and the like.

Next, the function of the embodiment will be described.

For example, when a hand-held or portable machine (not shown) possessed by the user detects a request signal that is transmitted from a smart ECU (not shown) on the vehicle, the portable machine returns an ID code stored therein to the smart ECU on the vehicle in response to the request signal so detected. The smart ECU compares the ID code of the portable machine to an ID code stored therein, and when the ID codes so compared coincide with each other, the smart ECU sends a control signal to the light ECU so as to turn on the lamps of the vehicle. As this occurs, the light ECU transmits a light emitting signal to the LED lamps 11 of the handle device adapted in a vehicle 1 so as to make the LED lamps 11 to emit light. Then, the user touches the portion of the electrode 7a in the lower surface portion Sa of the license plate lamp cover 5 by using the light emitted from the LED lamps 11 as a target mark, whereby when the electrostatic capacity between the pair of electrodes 7a, 7b exceeds the predetermined value, an ON signal is outputted to the door ECU 25. The door ECU 25 transmits an unlocking signal to the locking unit 27 based on the ON signal so outputted thereto. When receiving the unlocking signal, the locking unit 27 drives the drive unit, whereby the latch is moved so as to release the engagement with the striker 29 in the opening in the vehicle, so that the tailgate 21 is unlocked.

Thus, in the handle device adapted in a vehicle 1 according to the embodiment, the plurality of LED lamps 11 and the electrodes 7a, 7b of the electrostatic capacity type switch 7 for unlocking the locked tailgate are provided in parallel to each other. Furthermore, the electrodes 7a, 7b of the electrostatic capacity type switch 7 are provided to be offset relative to the illuminating direction of the LED lamps 11. By adopting this configuration, for example, with the LED lamps 11 made to illuminate the license plate 23, the position of the electrostatic capacity type switch 7 can be made to be visualized by the user. Consequently, the user is allowed to easily recognize the position of the relevant switch 7 for an ensured operation thereof. Furthermore, in the handle device adapted in a vehicle 1 according to the embodiment, the electrode 7a of the electrostatic capacity type switch 7, which is one of the electrodes thereof, extends in the transverse direction of the vehicle in the lower surface portion 5a of the license plate lamp cover 5, so that the sensitive portion of the relevant switch 7 is secured over the wide range. On the other hand, in the related art, the sensitive portion of the corresponding switch is limited to a specific area. Thus, in the handle device adapted in a vehicle 1 according to the embodiment, when compared to the conventional system, since the switch operation is made possible as long as the position of the electrostatic capacity type switch 7 can be recognized in general, the operability is increased.

Thus, while the embodiment of the invention has been described heretofore with respect to the best mode for carrying out the invention, the invention is not such as to be limited thereto, and hence, the embodiment can be modified and substituted variously without departing from the spirit and scope of the invention.

For example, while the invention is described by taking as an example the smart function which automatically certifies the ID code of the portable machine in the aforesaid embodiment, the LED lamps 11 of the handle device adapted in a vehicle 1 may be made to emit light through arbitrary operations by the user.

In addition, while the electrostatic capacity type switch 7 is used as the touch-type switch in the embodiment, an arbitrary touch-type switch including mechanical- and electrical-type switches can be used. As has been described above, the sensitive area of the switch may be provided in the transverse direction of the vehicle in parallel to the LED lamps 11.

The invention can be applied to a handle device provided on an vehicle door. The external appearance, weight, size and running performance of a vehicle on which the system is to be installed does not matter.

What is claimed is:

1. A handle device adapted in a vehicle comprising:
a touch-type switch provided on an operation handle for opening and closing an vehicle door so as to extend in a longitudinal direction of the operation door, so as to open and close the vehicle door; and
an illuminating portion provided so as to extend along the touch-type switch in parallel thereto, wherein the touch-type switch is provided to be offset relative to an illuminating direction of the illuminating portion.

2. A handle device adapted in a vehicle according to claim 1, wherein the illuminating portion has a plurality of LED lamps.

3. A handle device adapted in a vehicle according to claim 1, wherein the touch-type switch is an electrostatic capacity type switch.

4. A handle device adapted in a vehicle according to claim 3, wherein the electrostatic capacity type switch has a pair of electrodes and a detection circuit for detecting a change in electrostatic capacity between the electrodes.

5. A handle device adapted in a vehicle according to of claim 1, wherein the vehicle door is a side door, a tailgate, a rear door or a trunk lid.
